(19) United States
(12) Patent Application Publication
(10) Pub. No.: US 2018/0088712 A1
(43) Pub. Date: Mar. 29, 2018

(54) DISPLAY DEVICE AND METHOD OF MANUFACTURING THE SAME

(71) Applicant: Samsung Display Co., Ltd., Yongin-si (KR)

(72) Inventors: Yeontae KIM, Yongin-si (KR); Kicheol Kim, Yongin-si (KR); Youngsoo No, Seoul (KR); Kyungsu Lee, Suwon-si (KR); Hwan-hee Jeong, Cheonan-si (KR); Inyoung Han, Hwaseong-si (KR)

(21) Appl. No.: 15/668,471

(22) Filed: Aug. 3, 2017

(30) Foreign Application Priority Data
Sep. 23, 2016 (KR) 10-2016-0122456

(51) Int. Cl. G06F 3/041; G02F 1/1333; G02F 1/1343; G06K 9/00

(52) U.S. Cl. CPC G06F 3/0412; G02F 1/13338; G06K 9/0008; G06K 9/0002; G06F 2203/04103; G02F 1/1343

(57) ABSTRACT

A display device and method of manufacturing the same, wherein the display device includes a display panel including a display area and a non-display area, and a transparent layer disposed on the display panel and exposed to outside of the device. The transparent layer includes a first member, a second member disposed under the first member, and a fingerprint sensor disposed between the first member and the second member to recognize fingerprint information. A thickness of the first member is smaller than a thickness of the second member. The transparent layer may be a window layer. The first member may be a first window and the second member may be a second window.

### CROSS-REFERENCE TO RELATED APPLICATION

This application claims priority from and the benefit of Korean Patent Application No. 10-2016-0122456, filed on Sep. 23, 2016, which is hereby incorporated by reference for all purposes as if fully set forth herein.

### BACKGROUND

### Field

The invention relates generally to a display device and a method of manufacturing the same, and, more particularly, to a display device and a method of manufacturing the same that improves the sensitivity of a fingerprint sensor included in the display device.

### Discussion of the Background

As electronic devices such as smart phones, tablets and wearable devices have become more widely used, security and usability issues of the electronic devices have become more prominent. The security and the usability of the electronic device may be inversely related. Thus, the usability may decrease when the security is improved. However, when a two-dimensional (2D) fingerprint sensor is integrated together with a touch display, the usability of fingerprint recognition used for only high security may be improved significantly. User functionalities for a general touch using a touch screen panel (TSP) and a touch for recognizing a fingerprint may be accomplished by the same structure, and thus both security and usability may be obtained without being inversely related in a touch display.

The above information disclosed in this Background section is only for enhancement of understanding of the background of the inventive concepts, and, therefore, it may contain information that does not form the prior art that is already known in this country to a person of ordinary skill in the art.

### SUMMARY

Applicants recognized that the sensitivity of fingerprint sensors for fingerprint recognition can be impaired by the thickness of the protective window glass. In particular, when a fingerprint recognition sensor is disposed under the window glass, the thickness of the window glass can impair the sensitivity of the fingerprint recognition sensor.

Devices constructed according to the principles of the invention provide a display device, and a method of manufacturing the same, that improve fingerprint recognition sensitivity of a fingerprint sensor. For example, devices constructed according to the principles of the invention provide a thinner upper transparent layer and a thicker lower transparent layer in which the fingerprint recognition sensor is disposed between the thinner upper layer and the thicker lower layer, both of which layers may be made from window glass.

Additional aspects will be set forth in the detailed description which follows, and, in part, will be apparent from the disclosure, or may be learned by practice of the inventive concepts.

According to one aspect of the invention, a display device includes a display panel that includes a display area and a non-display area, and a transparent layer disposed on the display panel and exposed to outside of the device. The transparent layer includes a first member, a second member disposed under the first member, and a fingerprint sensor disposed between the first member and the second member to recognize fingerprint information. A thickness of the first member is smaller than a thickness of the second member.

The fingerprint sensor may overlap with the display area.

A planar area of the first member may be greater than a planar area of the second member.

The fingerprint sensor may include a plurality of sensors, and the fingerprint sensors may be spaced apart from each other.

The transparent layer may further include an adhesive member having one surface that adheres to the first member and another surface that adheres to the second member.

The adhesive member may be disposed between adjacent ones of the plurality of fingerprint sensors.

The display device may further include a fingerprint sensor driving unit overlapping the non-display area to drive the fingerprint sensor.

The display device may further include a touch layer disposed between the display panel and the transparent layer and including a touch sensor to sense a position of a touch applied from the outside.

The fingerprint sensor may include RX electrodes arranged at substantially equal distances and TX electrodes arranged at substantially equal distances, and the touch sensor may include RX electrodes arranged at substantially equal distances and TX electrodes arranged at substantially equal distances. The substantially equal distances between adjacent RX electrodes of the fingerprint sensor may be smaller than the substantially equal distances between adjacent RX electrodes of the touch sensor, and the substantially equal distances between adjacent TX electrodes of the fingerprint sensor may be smaller than the substantially equal distances between adjacent TX electrodes of the touch sensor.

The distance between the adjacent RX electrodes of the RX electrodes of the fingerprint sensor may be about 50 μm.

The touch layer may include an active area including the touch sensor, and a non-active area. The display device may further include a flexible circuit board having one side portion disposed on the non-active area, and a touch driving unit disposed on the flexible circuit board to drive the touch sensor.

Another side portion of the flexible circuit board may be disposed on a portion of a bottom surface of the first member overlapping with the non-display area. The display device may further include a fingerprint sensor driving unit disposed on the flexible circuit board to drive the fingerprint sensor.

The fingerprint sensor driving unit and the touch driving unit may be integrated with each other.

The transparent layer may include a window layer. The first member may include a first window; and, the second member may include a second window.

According to another aspect of the invention a method of manufacturing a display device may include the steps of providing a display panel including a display area and a non-display area, forming a transparent layer, and disposing the transparent layer on the display panel in such a way that the transparent layer is exposed to outside of the display panel. The forming of the transparent layer may include providing a first member, forming a fingerprint sensor on the first member, and disposing a second member on the first member. The fingerprint sensor may be disposed between the first member and the second member, and the first member may be exposed to outside of the display.

The step of forming of the transparent layer may further include etching the first member such that the first member has a smaller thickness than the second member.

The step of forming of the transparent layer may further include removing an edge area of the second member. The edge area of the second member may overlap with the non-display area.

The step of forming of the transparent layer may further include disposing a fingerprint sensor driving unit driving the fingerprint sensor on an edge area of the first member. The edge area of the first member may overlap the non-display area.

The step of forming the fingerprint sensor may include forming the fingerprint sensor overlapping the display area.

The step of forming the transparent layer may include forming a window layer. The step of providing a first member may include providing a first window. The step of disposing a second member on the first member may include disposing a second window on the first window.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the invention, and are incorporated in and constitute a part of this specification, illustrate exemplary embodiments of the invention, and, together with the description, serve to explain principles of the invention.

FIG. 1 is a perspective view of a first embodiment of a display device constructed according to the principles of the invention.

FIG. 2A is an exploded perspective view of the display device of FIG. 1.

FIG. 2B is an exploded perspective view of the window layer of the display device of FIG. 1.

FIG. 2C is a plan view of an RX electrode and a TX electrode of a touch sensor and an RX electrode and a TX electrode of the fingerprint sensor that may be employed in a display device according to the principles of the invention.

FIG. 3 is a partial cross-sectional view of the display device of FIG. 1.

FIG. 4 is a plan view of the window layer of FIG. 2B illustrating generally, rectangular, spaced fingerprint sensors arranged in columns.

FIG. 5 is a partial cross-sectional view of a second embodiment of a display device constructed according to the principles of the invention having adhesive in between open spaces in the fingerprint sensor.

FIG. 6 is a partial cross-sectional view of a third embodiment of a display device constructed according to the principles of the invention having a PCB that contacts the controller on the underside of the first window layer.

FIG. 7 is a plan view of a second embodiment of a window layer constructed according to the principles of the invention illustrating a single fingerprint sensor.

FIG. 8 is a plan view of a third embodiment of a window layer constructed according to the principles of the invention illustrating generally square, fingerprint sensors arranged in rows and columns.

FIG. 9 is a flow chart schematically illustrating an exemplary method of manufacturing a display device according to the principles of the invention.

FIG. 10 is a flow chart schematically illustrating an exemplary method of manufacturing a window layer according to the principles of the invention.

FIGS. 11A to 11E are cross-sectional views of the window layer of the display device of FIG. 1 during sequential steps in the method of FIG. 10.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

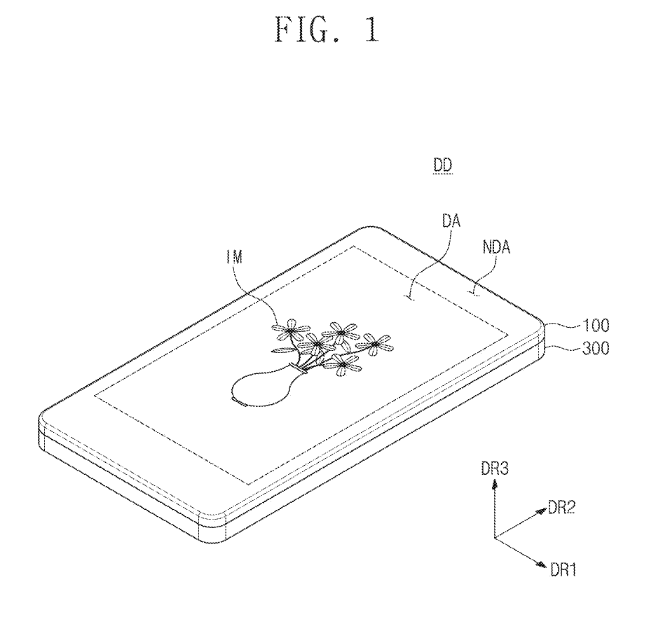

Referring to FIG. 1, a portable terminal is illustrated as an example of a display device DD. The portable terminal may include a tablet personal computer (tablet PC), a smart phone, a personal digital assistant (PDA), a portable multimedia player (PMP), a game console, a watch-type electronic device, and/or some other form of electronic device.

The display device DD may be applied to large-sized electronic devices (e.g., televisions or external billboards) and small and middle-sized electronic devices (e.g., personal computers, notebook computers, car navigation units, or cameras). These are provided as examples, and the display device DD may also be applied to other electronic devices without departing the spirit and scope of the inventive concepts.

As illustrated in FIG. 1, the display device DD includes a plurality of areas divided from each other on a display surface. The display device DD includes a display area DA on which an image IM is displayed, and a non-display area NDA adjacent to the display area DA. The display area DA may have a quadrilateral shape. The non-display area NDA surrounds the display area DA. In addition, the display device DD may include a partially curved shape. Thus, an area of the display area DA may have a curved shape.

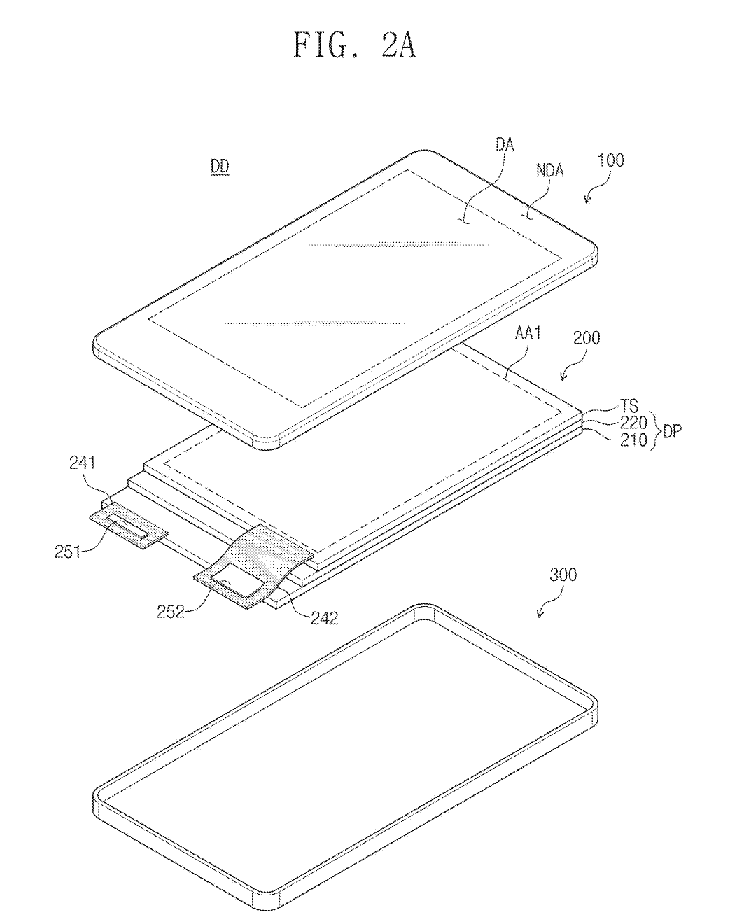

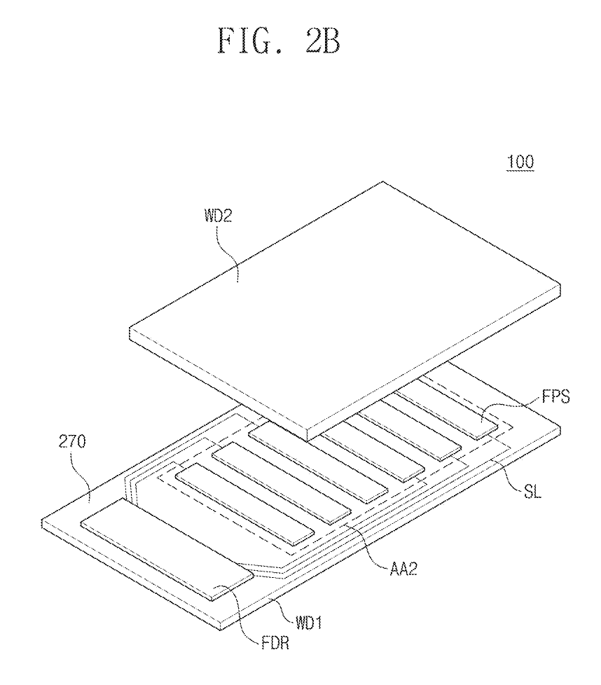

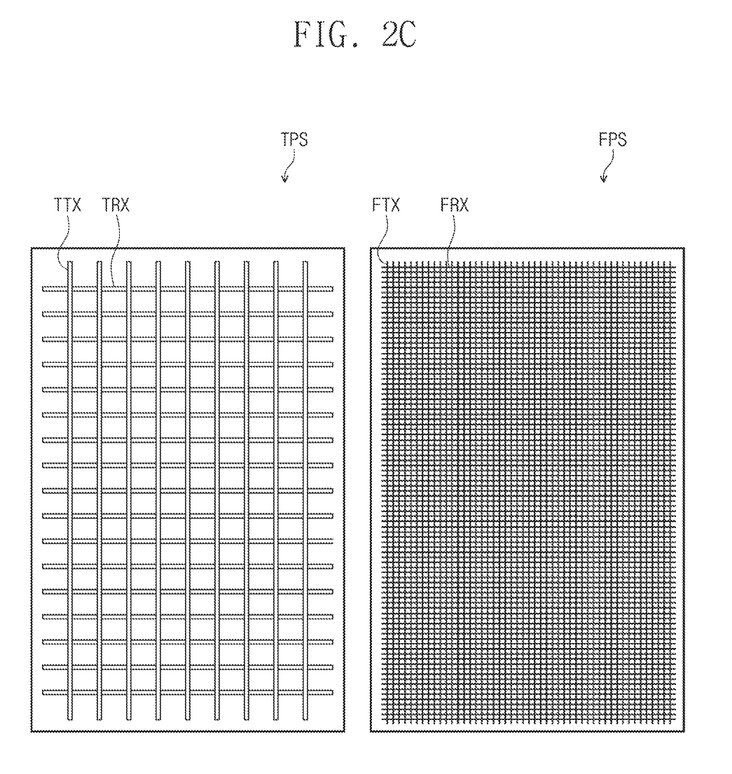

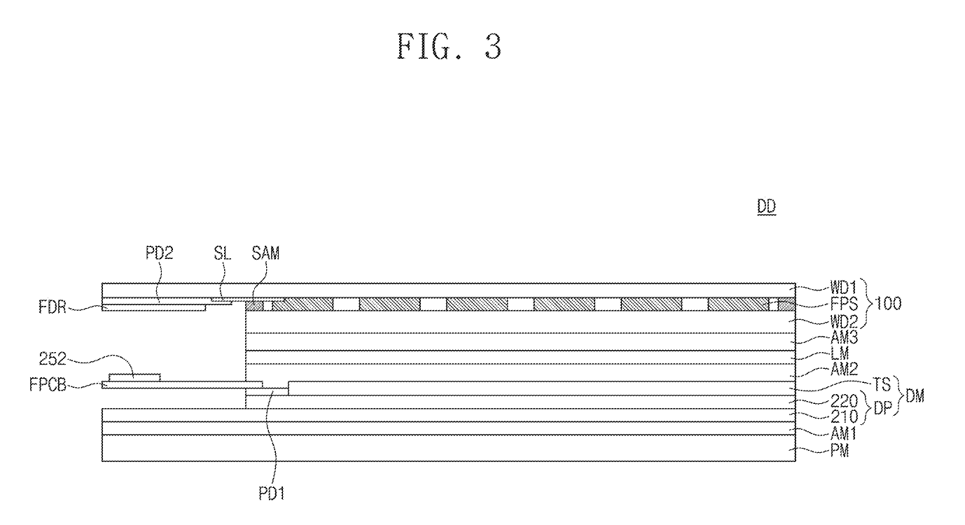

Referring to FIG. 2A, the display device DD may include a protective film PM (see FIG. 3), a window layer 100, a display module DM, an optical member LM (see FIG. 3), and a case 300.

The protective film PM protects the display module DM. The protective film PM prevents external moisture from permeating into the display module DM and absorbs external impact forces.

The protective film PM may include a plastic film as a base substrate. The plastic film of the protective film PM may include one or more plastic selected from a group consisting of polyethersulfone (PES), polyacrylate, polyetherimide (PEI), polyethylenenaphthalate (PEN), polyethyleneterephthalate (PET), polyphenylene sulfide (PPS), polyarylate, polyimide (PI), polycarbonate (PC), poly(arylene ethersulfone), and any combination thereof.

The material of the protective film PM is not limited to plastic resins but may include an organic/inorganic composite material. For example, the protective film PM may include a porous organic layer and an inorganic material filling pores of the porous organic layer. The protective film PM may further include a functional layer formed on the plastic film. The functional layer may include a resin layer. The functional layer may be formed by a coating method. Alternatively, the protective film PM may be omitted.

The display module DM disposed on the protective film PM may include a display panel DP and a touch layer TS. The display panel DP may include a display area DA displaying an image and a non-display area NDA. The display area DA of the display panel DP may correspond to the display area DA of the display device DD, and the non-display area NDA of the display panel DP may correspond to the non-display area NDA of the display device DD.

The display panel DP may include a lower substrate 210 and an upper substrate 220. The lower substrate 210 may include a plurality of pixels as is known in the art positioned in the display area DA, and a plurality of signal lines connected to the pixels. The signal lines may include a plurality of gate lines extending in a second direction DR2 and arranged in a first direction DR1. The gate lines may intersect and be insulated from data lines.

The pixels may be arranged in a matrix form defined by the first direction DR1 and the second direction DR2. Each of the pixels may be connected to a corresponding one of the gate lines and a corresponding one of the data lines. The pixels may receive electrical signals from corresponding gate lines and corresponding data lines to generate an image.

The upper substrate 220 may be disposed on the lower substrate 210. The upper substrate 220 may include a display element displaying the image.

The display module DM may include at least one of various display elements. For example, the display element may be a liquid crystal capacitor, an organic light-emitting element, an electrophoretic element, or an electro-wetting element. The display element may include a plurality of organic light-emitting elements (e.g., organic light-emitting diodes). For illustrative purposes, the display device DD will now be described as an organic light-emitting display device DD including the organic light-emitting display panel DP.

As illustrated in FIG. 2A, one end of a first flexible circuit board 241 may be disposed on an edge area of the lower substrate 210 connected to at least a portion of the signal lines disposed on the lower substrate 210. The first flexible circuit board 241 may be bonded to the lower substrate 210 through a pad formed on the edge area of the lower substrate 210.

A display driving unit 251 may be disposed on the first flexible circuit board 241. The display driving unit 251 may be connected to at least a portion of the signal lines disposed on the lower substrate 210 through the first flexible circuit board 241 to provide an electrical signal to each of the pixels. The display driving unit 251 may be mounted on the first flexible circuit board 241 by a chip-on-film (COF) method, or, by some other method known in the art.

The touch layer TS may be disposed on the display panel DP. A first active area AA1 capable of sensing an external touch (provided from outside the DP) may be defined in the touch layer TS. The touch layer TS may sense a position of the external touch provided from the outside on the basis of the first active area AA1. In more detail, the touch layer TS may include a touch sensor TPS illustrated in FIG. 2C that includes a TX electrode TTX illustrated in FIG. 2C and an RX electrode TRX illustrated in FIG. 2C.

The TX electrode TTX and the RX electrode TRX of the touch sensor TPS may include indium-tin oxide (ITO), indium-zinc oxide (IZO), zinc oxide (ZnO), indium-tin-zinc oxide (ITZO), PEDOT, metal nanowire, and/or graphene. The TX electrode TTX and the RX electrode TRX of the touch sensor TPS may include a metal layer including, for example, molybdenum, silver, titanium, copper, aluminum, or any alloy thereof.

The touch sensor TPS may obtain information concerning the position of the touch inputted from the outside. For example, the touch sensor TPS may sense an external input (e.g., the touch) in a capacitive manner.

A second flexible circuit board 242 may be electrically connected onto a first non-active area of the touch layer TS, which does not sense a touch. The second flexible circuit board 242 may be bonded to the first non-active area through a first pad PD1 illustrated in FIG. 3.

A touch driving unit 252 may be disposed on the second flexible circuit board 242. The touch driving unit 252 may output touch driving signals to drive the touch sensor TPS. The touch driving signals outputted from the touch driving unit 252 may be provided to the touch sensor TPS through the second flexible circuit board 242.

The optical member LM may be disposed on the display module DM. The optical member LM may reduce the reflectance of external light. The optical member LM may include at least a polarizing film. The optical member LM may further include a phase-difference film. Alternatively, the optical member LM may be omitted.

The case 300 may be coupled to the window layer 100, the display module DM, the protective film PM, and the optical member LM. The case 300 may be formed of a metal having conductivity. In other words, the case 300 may be conductively coupled to the window layer 100, the display module DM, the protective film PM, and the optical member LM. The case 300 may absorb external impact to protect the window layer 100, the display module DM, the protective film PM, and the optical member LM.

The window layer 100 may be disposed on the display module DM. The window layer may include one or more transparent members.

The window layer 100 may include a first window WD1 as an example of a first member, a second window WD2 as an example of a second member, and a fingerprint sensor FPS. The window layer 100 may further include a multi-layered structure including plastic films. The window layer 100 may further include a multi-layered structure selected from a group consisting of a glass substrate, a plastic film, and a plastic substrate. The window layer 100 may be exposed outward.

The first window WD1 and the second window WD2 may have plate-like shapes. The first window WD1 and the second window WD2 may be substantially transparent. For example, the first window WD1 and the second window WD2 may include glass or a transparent polymer and/or may have a multi-layered structure selected therefrom.

The first window WD1 may be exposed outward, and the first and second windows WD1 and WD2 may include a bezel pattern. The multi-layered structure may be formed by continuous processes or by a bonding process using an adhesive layer.

The fingerprint sensor FPS may be disposed between the first window WD1 and the second window WD2. The fingerprint sensor FPS may be disposed on a rear surface of the first window WD1. A second active area AA2 and a second non-active area may be positioned at the rear surface of the first window WD1. The fingerprint sensor FPS can sense a touch provided from the outside in the second active area AA2, and the second non-active area does not sense the touch. The second active area AA2 may overlap with the display area DA. The fingerprint sensor FPS may overlap with the second active area AA2.

The fingerprint sensor may recognize or sense a fingerprint provided from the outside. In more detail, the fingerprint sensor FPS may recognize information of the fingerprint provided from the outside. The fingerprint sensor FPS may recognize the fingerprint provided to an outer surface of the first window WD1 in a capacitive manner. The fingerprint sensor FPS may obtain the fingerprint information in a self-capacitance manner or a mutual-capacitance manner, as is known in the art.

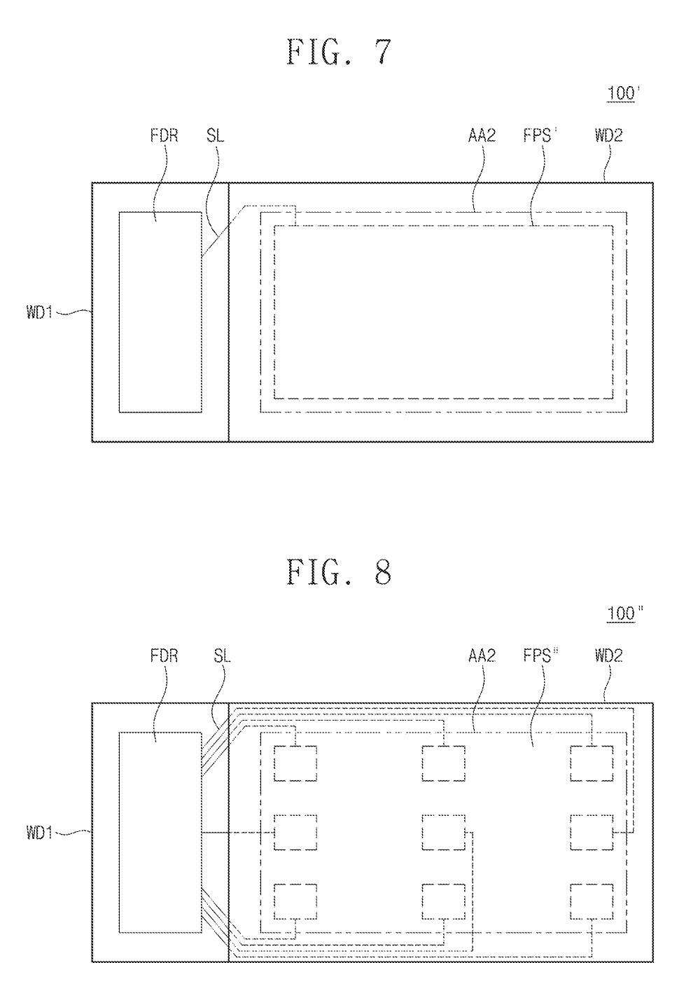

The fingerprint sensor FPS may be provided in plural. The plural fingerprint sensors FPS may be spaced apart from each other. The fingerprint sensor FPS may have a rectangular bar shape when viewed in a plan view, as illustrated in FIG. 2B. The shape of the fingerprint sensor FPS may vary. This will be described in more detail below with reference to FIGS. 7 and 8. In addition, six fingerprint sensors FPS are illustrated in FIG. 2B. However, the number of the fingerprint sensors FPS is not limited to that number.

The fingerprint sensor FPS may include a TX electrode FTX and an RX electrode FRX. The TX electrode FTX and the RX electrode FRX of the fingerprint sensor FPS may include indium-tin oxide (ITO), indium-zinc oxide (IZO), zinc oxide (ZnO), indium-tin-zinc oxide (ITZO), PEDOT, metal nanowire, and/or graphene. The TX electrode FTX and the RX electrode FRX of the fingerprint sensor FPS may include a metal layer including, for example, molybdenum, silver, titanium, copper, aluminum, or any alloy thereof.

A fingerprint sensor driving unit FDR may be disposed on the rear surface of the first window WD1, which overlaps with the second non-active area, as shown in FIG. 3. In addition, the fingerprint sensor driving unit FDR may overlap with the non-display area NDA. The fingerprint sensor driving unit FDR may be mounted on the rear surface of the first window WD1 by a chip-on-glass (COG) method, or, by some other method.

The fingerprint sensor driving unit FDR may be electrically connected to the fingerprint sensor FPS through a sensing interconnection line SL. The fingerprint sensor driving unit FDR may output driving signals to drive the fingerprint sensor FPS. The fingerprint sensor driving unit FDR may output the driving signals, to drive the fingerprint sensor FPS, through the sensing interconnection line SL.

FIG. 2C illustrates the RX electrode TRX and the TX electrode TTX of the touch sensor TPS and the RX electrode FRX and the TX electrode FTX of the fingerprint sensor FPS.

The embodiment of FIG. 2C may be applied to the RX electrodes TRX and the TX electrodes TTX of the touch sensor TPSs and the RX electrodes FRX and the TX electrodes FTX of the fingerprint sensors FPS of other embodiments of the display device DD.

Referring to FIG. 2C, the RX electrode TRX of the touch sensor TPS may be provided in plural. The RX electrodes TRX of the touch sensor TPS may be arranged at equal distances in one direction.

The TX electrode TTX of the touch sensor TPS may be provided in plural. The TX electrodes TTX of the touch sensor TPS may be arranged at equal distances in a direction perpendicular to the arrangement direction of the RX electrodes TRX of the touch sensor TPS.

The TX electrode TTX of the touch sensor TPS may receive the touch driving signal from the touch driving unit 252.

The RX electrode TRX of the touch sensor TPS may sense a variation in capacitance, which occurs by a touch.

The touch sensor TPS may sense a position of the touch by using the TX electrode TTX receiving the touch driving signal and the RX electrode TRX sensing the variation in capacitance.

The RX electrode FRX of the fingerprint sensor FPS may be provided in plural. The RX electrodes FRX of the fingerprint sensor FPS may be arranged at equal distances in one direction.

The TX electrode FTX of the fingerprint sensor FPS may be provided in plural. The TX electrodes FTX of the fingerprint sensor FPS may be arranged at equal distances in a direction perpendicular to the arrangement direction of the RX electrodes FRX of the fingerprint sensor FPS.

When a user's finger touches the fingerprint sensor FPS, charges may be transmitted from the TX electrode FTX of the fingerprint sensor FPS to the RX electrode FRX of the fingerprint sensor FPS. At this time, a capacitance value received in the RX electrode FRX of the fingerprint sensor FPS may vary according to a distance between the finger and the TX electrode FTX of the fingerprint sensor FPS. Because this value is inversely proportional to the distance, a ridge-shaped portion and a valley-shaped portion of a fingerprint may be determined based on the value, the distance, and/or the relationship of the value and the distance.

The distance between adjacent TX electrodes of the TX electrodes FTX of the fingerprint sensor FPS may be smaller than the distance between adjacent TX electrodes of the TX electrodes TTX of the touch sensor TPS. This may be because the fingerprint sensor FPS measures the ridge and the valley of the fingerprint whereas the touch sensor TPS measures a location and/or magnitude of a touch of a larger portion of a fingertip. In other words, the TX electrodes FTX of the fingerprint sensor FPS may be denser than the TX electrodes TTX of the touch sensor TPS.

For example, the distance between adjacent TX electrodes of the TX electrodes FTX of the fingerprint sensor FPS may be 50 μm, and the distance between adjacent TX electrodes of the TX electrodes TTX of the touch sensor TPS may be several millimeters.

The distance between adjacent RX electrodes of the RX electrodes FRX of the fingerprint sensor FPS may be smaller than the distance between adjacent RX electrodes of the RX electrodes TRX of the touch sensor TPS. This may be because the fingerprint sensor FPS measures the ridge and the valley of the fingerprint whereas the touch sensor TPS measures a location and/or magnitude of a touch of a larger portion of the fingertip. In other words, the RX electrodes FRX of the fingerprint sensor FPS may be denser than the RX electrodes TRX of the touch sensor TPS.

For example, the distance between adjacent RX electrodes of the RX electrodes FRX of the fingerprint sensor FPS may be 50 μm, and the distance between adjacent RX electrodes of the RX electrodes TRX of the touch sensor TPS may be several millimeters.

Hereinafter, the descriptions of the same features and/or elements as in FIGS. 2A and 2B will be omitted, or only mentioned briefly, for the purpose of ease and convenience in explanation.

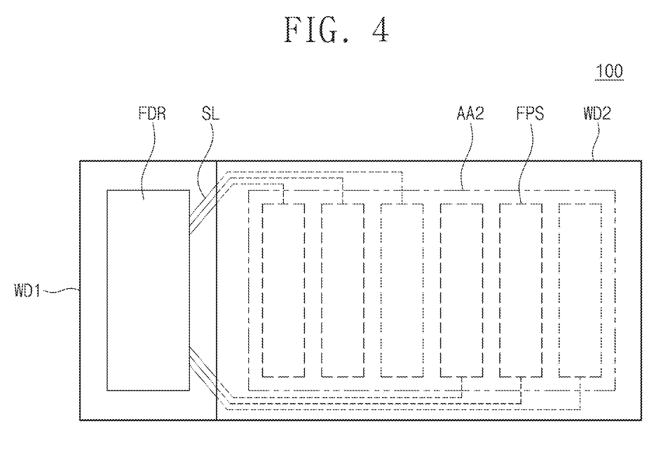

Referring to FIGS. 3 and 4, the display device DD may include the protective film PM, the display module DM, the optical member LM, the window layer 100, a first adhesive member AM1, a second adhesive member AM2, and a third adhesive member AM3. The display module DM may be disposed between the protective film PM and the optical member LM. The optical member LM may be disposed between the display module DM and the window layer 100. The first adhesive member AM1 may couple the display module DM and the protective film PM to each other, the second adhesive member AM2 may couple the display module DM and the optical member LM to each other, and the third adhesive member AM3 may couple the optical member LM and the window layer 100 to each other.

Rather than being separately formed in separate processes and subsequently adhered to each other with an adhesive layer therebetween, the touch layer TS may be disposed directly on the display panel DP such that the touch layer TS and display panel DP are formed in a continuous process that obviates the need for an additional adhesive layer between the touch layer TS and the display panel DP.

In addition, the display module DM may further include an anti-reflection layer. The anti-reflection layer may include a color filter or a stack structure of a conductive layer/an insulating layer/a conductive layer. The anti-reflection layer may absorb, destructively interfere with or polarize light incident from the outside to reduce a reflectance of external light. The anti-reflection layer may be substituted for the function of the optical member LM.

Each of the first, second, and third adhesive members AM1, AM2, and AM3 may be an organic adhesive layer such as an optically clear adhesive (OCA) film, an optically clear resin (OCR), or a pressure sensitive adhesive (PSA) film. The organic adhesive layer may include an adhesive material such as a polyurethane-based adhesive material, a polyacryl-based adhesive material, a polyester-based adhesive material, a polyepoxy-based adhesive material, or a polyacetate vinyl-based adhesive material. In other words, the organic adhesive layer may correspond to one of organic layers.

A window adhesive member SAM may couple the first window WD1 to the second window WD2. For example, one surface of the window adhesive member SAM may adhere to an edge area of the first window WD1, and another surface of the window adhesive member SAM may adhere to an edge area of the second window WD2.

The first window WD1 may be disposed at the outermost portion of the display device DD. In other words, a user may view an image through the first window WD1 of the display device DD.

The sensing interconnection line SL extending from the fingerprint sensor FPS may be electrically connected to a second pad PD2 disposed on a bottom surface of the first window WD1.

The fingerprint sensor driving unit FDR may be mounted on the second pad PD2 by the COG method, and thus the fingerprint sensor driving unit FDR and the fingerprint sensor FPS may be electrically connected to each other through the sensing interconnection line SL.

Because the fingerprint sensor FPS is formed on the bottom surface of the first window WD1 and is disposed between the first and second windows WD1 and WD2 as described above, fingerprint recognition sensitivity is improved by the window structure described herein.

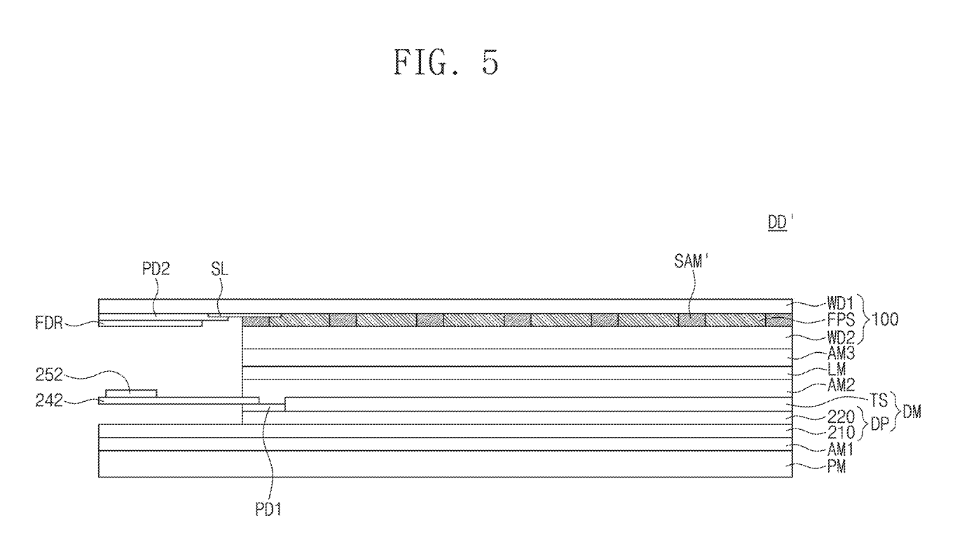

Referring to FIG. 5, a window adhesive member SAM′ may be disposed between the fingerprint sensors FPS. For example, the window adhesive member SAM′ may be interposed between the fingerprint sensors FPS to better adhere the first window WD1 and the second window WD2 to each other.

Other elements or components of the display device DD′ may be the same as corresponding elements or components of the display device DD of FIG. 3, and thus the descriptions thereof are omitted.

Because the window adhesive member SAM′ is also disposed between the fingerprint sensors FPS, unlike the FIG. 3 embodiment, the adhesive strength between the first and second windows WD1 and WD2 may be further improved.

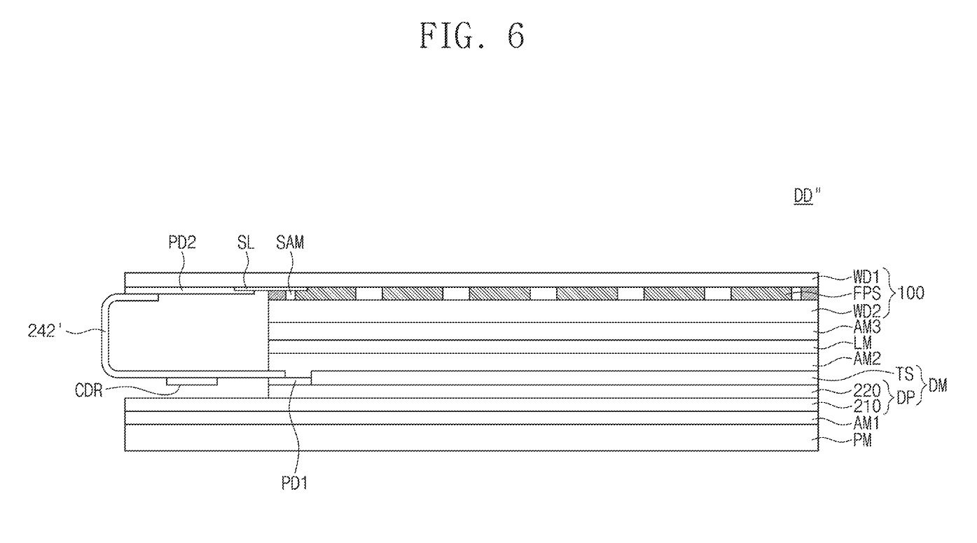

Referring to FIG. 6, one side portion of a second flexible circuit board 242′ may be disposed on the first non-active area, and another side portion of the second flexible circuit board 242′ may be disposed on a portion of the bottom surface of the first window WD1, which overlaps with the non-display area NDA.

An integrated driving unit CDR may be disposed on the second flexible circuit board 242′.

The integrated driving unit CDR may perform both the functions of the fingerprint sensor driving unit FDR and the functions of the touch driving unit 252, described with reference to FIG. 3.

Other elements or components of the display device DD″ may be the same as corresponding elements or components of the display device DD of FIG. 3, and thus the descriptions thereof are omitted.

Because the integrated driving unit CDR is disposed on the second flexible circuit board 242′ as described above, the display device can be thinner and smaller than it otherwise would be.

Referring to FIG. 7, a single fingerprint sensor FPS′ may be provided. For example, the fingerprint sensor FPS′ may be formed on all or substantially all of the second active area AA2 rather than only on certain portions of the second active area AA2.

Referring to FIG. 8, a fingerprint sensor FPS″ may be provided in plural and the fingerprint sensors FPS″ may be spaced apart from each other by certain distances. As illustrated in FIG. 8, the number of the fingerprint sensors FPS″ may be nine and each of the fingerprint sensors FPS″ may have a substantially quadrilateral shape when viewed in a plan view.

Features and functions of the fingerprint sensors FPS′ and FPS″ and other elements or components may be the same as described above, and thus the descriptions thereof are omitted.

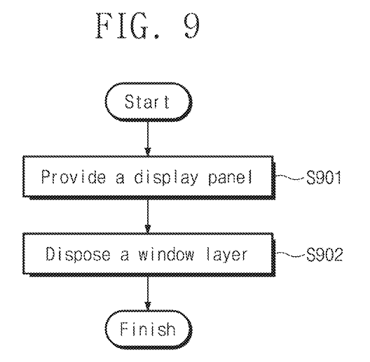

Referring to FIG. 9, basic steps in an exemplary method of manufacturing a display device are shown. To manufacture the display device DD, a display panel DP (see FIG. 3) is provided (S901). The display panel DP may be the same as described above.

Next, a window layer 100 (see FIG. 3) is disposed on the display panel DP (S902).

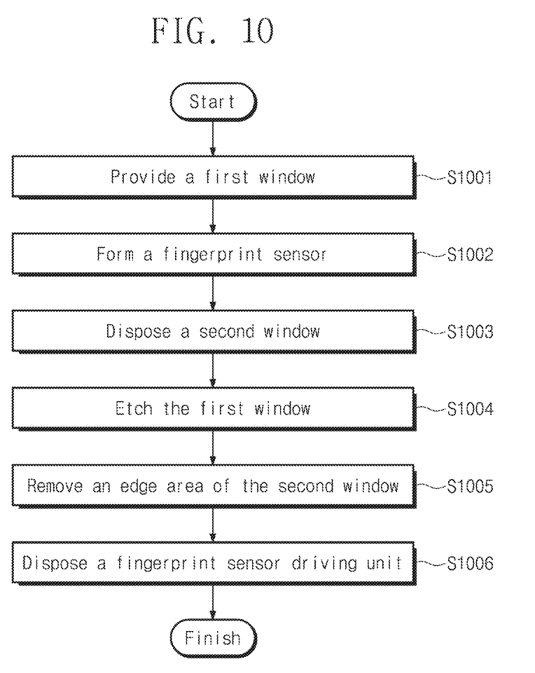

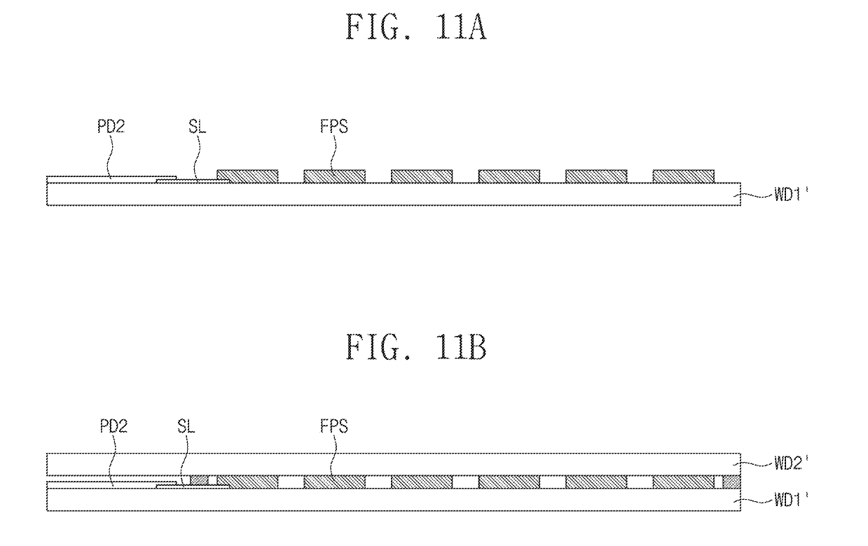

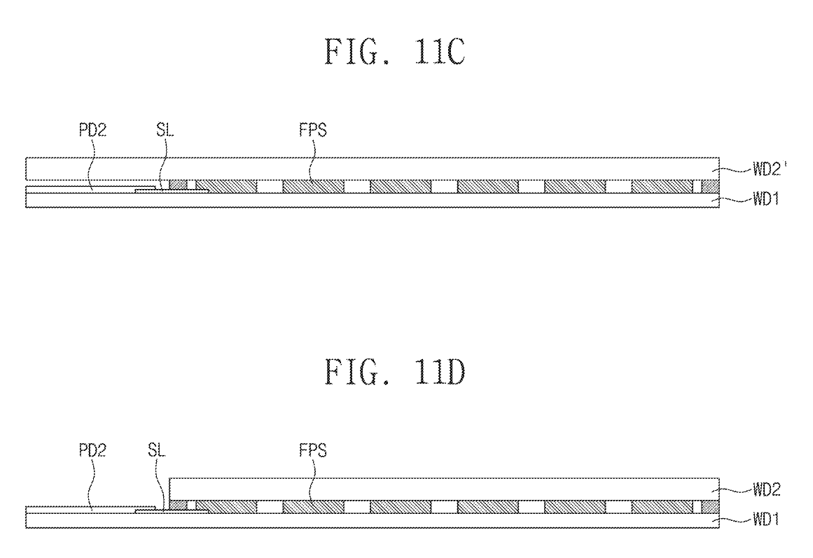

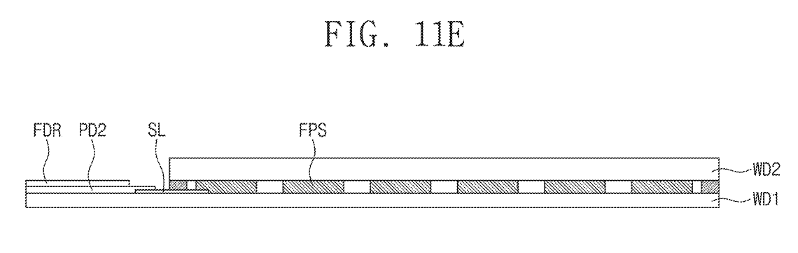

Hereinafter, a method of manufacturing or forming the window layer 100 will be described with reference to FIGS. 10 and 11A to 11E.

A first window WD1′ is provided (S1001). The first window WD1′ may be the same as described above, and thus detailed descriptions thereof are omitted.

Referring to FIGS. 10 and 11A, a fingerprint sensor FPS is formed on the first window WD1′ (S1002). An indium-tin oxide (ITO) layer may be formed on the first window WD1′, a patterning process using a photolithography process may be performed on the ITO layer to form TX electrodes FTX (see FIG. 2C) and RX electrodes FRX (see FIG. 2C) may be included in the fingerprint sensor FPS. Other features of the fingerprint sensor FPS may be the same as described above, and thus the descriptions thereof are omitted.

Referring to FIGS. 10 and 11B, a second window WD2′ is disposed on the first window WD1′ (S1003). The second window WD2′ may be disposed on the first window WD1′ in such a way that the fingerprint sensor FPS is disposed between the first window WD1′ and the second window WD2′.

Referring to FIGS. 10 and 11C, the first window WD1′ is etched such that a thickness of the first window WD1′ becomes smaller than a thickness of the second window WD2′ (S1004). Thus, a thinner first window WD1 may be formed. Since the first window WD1′ is disposed at the outermost portion of the display device DD (see FIG. 3) to be manufactured and may be etched to reduce the thickness of the first window WD1′, it is possible to increase the touch recognition sensitivity of the fingerprint sensor FPS as compared to a conventional single window implementation.

Referring to FIGS. 10 and 11D, an edge area of the second window WD2′ is removed (S1005). Thus, the second window WD2 of FIG. 3 may be formed. For example, the edge area of the second window WD2′ may be removed by an etching process.

Referring to FIGS. 10 and 11E, a fingerprint sensor driving unit FDR may be disposed on a portion of a bottom surface of the first window WD1, which corresponds to the edge area of the second window WD2 (S1006). The fingerprint sensor driving unit FDR may be the same as described above, and thus the descriptions thereof are omitted.

The fingerprint sensor may be formed on the bottom surface of the first window and may be disposed between the first window and the second window. Thus, the fingerprint recognition sensitivity may be increased as compared to the alternative.

Although certain exemplary embodiments and implementations have been described herein, other embodiments and modifications will be apparent from this description. Accordingly, the inventive concepts are not limited to such embodiments, but rather to the broader scope of the presented claims and various obvious modifications and equivalent arrangements.

What is claimed is:

1. A display device comprising:
a display panel including a display area and a non-display area; and
a transparent layer disposed on the display panel and exposed to outside of the device,
wherein the transparent layer comprises:
a first member;
a second member disposed under the first member; and
a fingerprint sensor disposed between the first member and the second member to recognize fingerprint information,
wherein a thickness of the first member is smaller than a thickness of the second member.

2. The display device of claim 1, wherein the fingerprint sensor overlaps the display area.

3. The display device of claim 1, wherein a planar area of the first member is greater than a planar area of the second member.

4. The display device of claim 1, wherein the fingerprint sensor comprises a plurality of sensors, and
wherein the fingerprint sensors are spaced apart from each other.

5. The display device of claim 4, wherein the transparent layer further comprises: an adhesive member having one surface that adheres to the first member and another surface that adheres to the second member.

6. The display device of claim 5, wherein the adhesive member is disposed between adjacent ones of the plurality of the fingerprint sensors.

7. The display device of claim 1, further comprising:
a fingerprint sensor driving unit overlapping the non-display area to drive the fingerprint sensor.

8. The display device of claim 1, further comprising:
a touch layer disposed between the display panel and the transparent layer and including a touch sensor to sense a position of a touch applied from the outside.

9. The display device of claim 8, wherein the fingerprint sensor includes RX electrodes arranged at substantially equal distances and TX electrodes arranged at substantially equal distances,
wherein the touch sensor includes RX electrodes arranged at substantially equal distances and TX electrodes arranged at substantially equal distances,
wherein the substantially equal distances between adjacent RX electrodes of the fingerprint sensor are smaller than the substantially equal distances between adjacent RX electrodes of the touch sensor, and
wherein the substantially equal distances between adjacent TX electrodes of the fingerprint sensor are smaller than the substantially equal distances between adjacent TX electrodes of the touch sensor.

10. The display device of claim 9, wherein the distance between the adjacent RX electrodes of the RX electrodes of the fingerprint sensor is about 50 μm.

11. The display device of claim 8, wherein the touch layer includes: an active area including the touch sensor; and a non-active area, the display device further comprising:
a flexible circuit board having one side portion disposed on the non-active area; and
a touch driving unit disposed on the flexible circuit board to drive the touch sensor.

12. The display device of claim 11, wherein another side portion of the flexible circuit board is disposed on a portion of a bottom surface of the first member overlapping the non-display area, the display device further comprising:
a fingerprint sensor driving unit disposed on the flexible circuit board to drive the fingerprint sensor.

13. The display device of claim 12, wherein the fingerprint sensor driving unit and the touch driving unit are integrated with each other.

14. The display device of claim 1, wherein the transparent layer comprises a window layer, the first member comprises a first window and the second member comprises a second window.

15. A method of manufacturing a display device, the method comprising the steps of:
providing a display panel including a display area and a non-display area;
forming a transparent layer; and
disposing the transparent layer on the display panel in such a way that the transparent layer is exposed to outside of the display panel,
wherein the forming of the transparent layer comprises:
providing a first member;
forming a fingerprint sensor on the first member; and
disposing a second member on the first member,
wherein the fingerprint sensor is disposed between the first member and the second member, and
wherein the first member is exposed to outside of the display.

16. The method of claim 15, wherein the step of forming of the transparent layer further comprises:
etching the first member such that the first member has a smaller thickness than the second member.

17. The method of claim 15, wherein the step of forming of the transparent layer further comprises:
removing an edge area of the second member,
wherein the edge area of the second member overlaps with the non-display area.

18. The method of claim 15, wherein the step of forming of the transparent layer further comprises:
disposing a fingerprint sensor driving unit driving the fingerprint sensor on an edge area of the first member,
wherein the edge area of the first member overlaps the non-display area.

19. The method of claim 15, wherein the step of forming the fingerprint sensor includes forming the fingerprint sensor overlapping the display area.

20. The method of claim 15, wherein
the step of forming the transparent layer comprising forming a window layer,
the step of providing a first member comprises providing a first window, and
the step of disposing a second member on the first member comprises disposing a second window on the first window.
